(19) United States
(12) Patent Application Publication
(10) Pub. No.: US 2012/0047109 A1
(43) Pub. Date: Feb. 23, 2012

(54) DATA STRUCTURE PRODUCTION METHOD AND BACKUP DEVICE

(75) Inventors: Daisuke HAYASHI, Nara (JP); Hideaki Mita, Hyogo (JP)

(73) Assignee: Panasonic Corporation, Osaka (JP)

(21) Appl. No.: 12/973,903

(22) Filed: Dec. 21, 2010

(30) Foreign Application Priority Data
Aug. 19, 2010 (JP) 2010-183579

(51) Int. Cl. G06F 17/30

(52) U.S. Cl. 707/640; 707/829; 707/679; 707/E17.007

(57) ABSTRACT

There is provided a data structure production method for producing a multilevel directory structure in a backup device. The multilevel directory structure includes target data having at least one of video data and audio data. The data structure production method includes producing a first directory that establishes a first directory hierarchy, producing at least one second directory that establishes a second directory hierarchy lower than the first directory hierarchy wherein the target data is stored in the at least one second directory, and storing the at least one second directory in the first directory provided the first directory is less than or equal to a predetermined size.

### CROSS-REFERENCE TO RELATED APPLICATIONS

This application claims priority to Japanese Patent Application No. 2010-183579, filed on Aug. 8, 2010. The entire disclosure of Japanese Patent Application No. 2010-183579 is hereby incorporated herein by reference.

### BACKGROUND

1. Technical Field

The present invention relates to a data structure production method used during the backup of video data, audio data, or both, and to a backup device that makes use of this method.

2. Background Information

Because of their good reliability, high recording capacity, and low cost, tape-form recording media are often used as recording media for backing up video data and/or audio data recorded with a video camera or the like. In particular, tape-form recording media are often used by broadcast stations, production teams, or the like that handles large volumes of video and audio data.

A tape-form recording medium cannot be randomly accessed. Therefore, a drawback to using a tape-form recording medium is that “seek time” can be considerable during the backup and/or restoration of data.

In view of this, there has been disclosed a technique with which, in the backup of data, related files are stored in areas with nearby physical addresses in the tape-form recording medium (see Japanese Laid-Open Patent Application H6-44118). With the technique of Japanese Patent Application H6-44118, related files can be efficiently restored from a tape-form recording medium.

### SUMMARY

However, it has been discovered that when files have been recorded here and there in a tape-form recording medium, the seek time for restoring these files can be considerably long. As such, high-speed restoration cannot be achieved.

When data recorded for a broadcast business is backed up on a tape-form recording medium, there are situations in which all of the data is restored in the editing process, but it is common for just part of the data to be restored. If the time it took to restore data in such situations could be shortened, the work flow of data editing for a broadcast business could be improved.

In view of the state of the known technology, it is at least one object of the present invention to make it possible for files that have been recorded here and there in a recording medium to be efficiently restored.

Accordingly, there is provided a data structure production method for producing a multilevel directory structure in a backup device. The multilevel directory structure includes target data having at least one of video data and audio data. The data structure production method includes producing a first directory that establishes a first directory hierarchy, producing at least one second directory that establishes a second directory hierarchy lower than the first directory hierarchy wherein the target data is stored in the at least one second directory, and storing the at least one second directory in the first directory provided the first directory is less than or equal to a predetermined size.

These and other objects, features, aspects and advantages of the present invention will become apparent to those skilled in the art from the following detailed description, which, taken in conjunction with the annexed drawings, discloses embodiments of the present invention.

### BRIEF DESCRIPTION OF DRAWINGS

FIG. 1 is a block diagram of the configuration of a backup device pertaining to Embodiment 1;

FIG. 2 is a diagram of the basics of backup processing and restoration processing pertaining to Embodiment 1;

FIG. 3 is a diagram of a directory structure prior to conversion to backup use pertaining to Embodiment 1;

FIG. 4 is a diagram of a directory structure after conversion to backup use pertaining to Embodiment 1;

FIG. 5 is a flowchart of production processing for a directory structure pertaining to Embodiment 1;

FIG. 6 is a diagram illustrating decision processing for restore target directories pertaining to Embodiment 1;

FIG. 7 is a flowchart of decision processing for restore target directories pertaining to Embodiment 1;

FIG. 8 is a diagram illustrating parallel processing for restoration pertaining to Embodiment 1;

FIG. 9 is a flowchart of production processing for a directory structure pertaining to a modification of Embodiment 1;

FIG. 10 is a diagram illustrating a plurality of data sets from the same clock time pertaining to Embodiment 2;

FIG. 11 is a diagram of a virtual directory structure pertaining to Embodiment 2; and

FIG. 12 is a diagram illustrating a directory for metadata pertaining to Embodiment 3.

### DETAILED DESCRIPTION OF THE EMBODIMENTS

### Embodiment 1

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

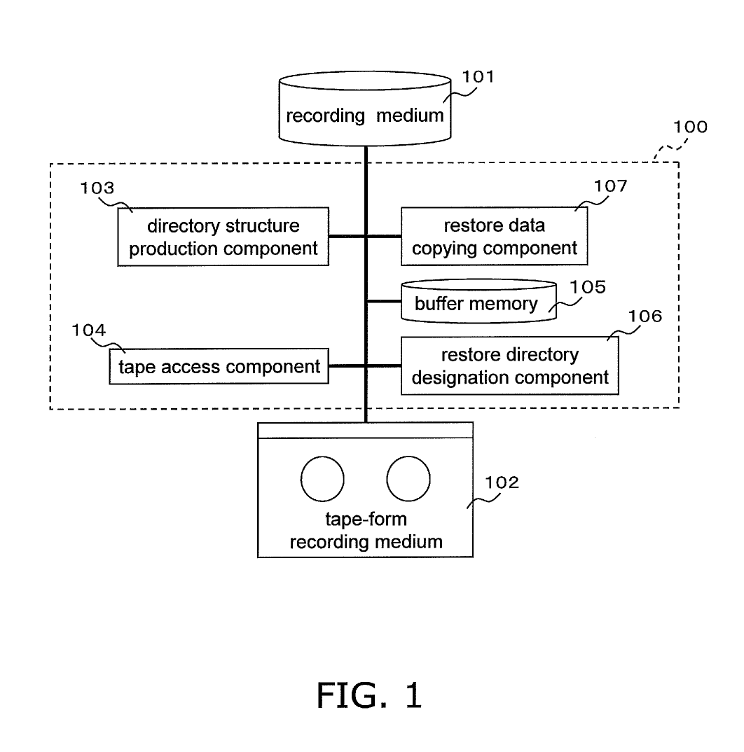

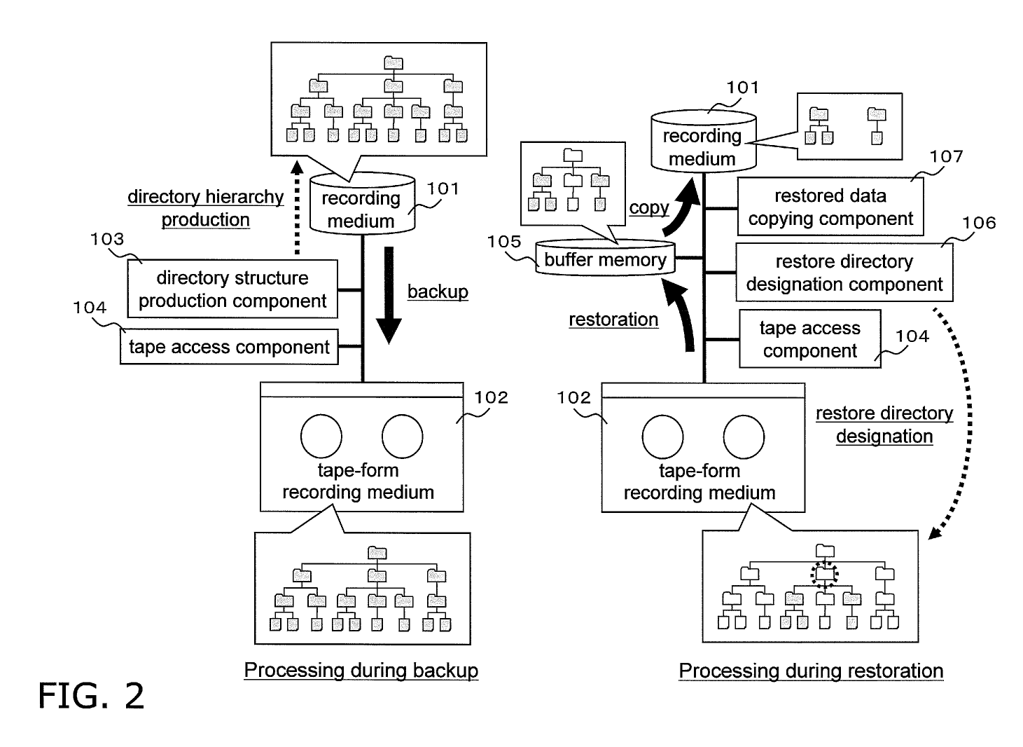

FIG. 1 is a block diagram of the configuration of a backup device 100 pertaining to this embodiment. FIG. 2 shows the flow of processing during backup and the flow of processing during restoration. The data to be backed up and the data to be restored in this embodiment are video data, audio data, or both.

First, a method for backing up data stored on a recording medium 101 to a tape-form recording medium 102 will be described.

The recording medium 101 is a recording medium on which the data to be backed up is stored. The recording medium 101 may be of any type, so long as it is a recording medium that can be randomly accessed, such as a hard disk, an optical disk, or a semiconductor memory. The recording medium 101 may be built into the backup device 100, or may be a type that can be attached to and removed from the backup device 100, or may be a type that is connected to the backup device 100 via any of various kinds of network, etc.

The tape-form recording medium 102 is a tape medium that is used to back up data stored on the recording medium 101. The tape-form recording medium 102 may be of any type, so long as it is a tape-form recording medium such as LTO (linear tape-open) or DLT (digital linear tape). The tape-form recording medium 102 may be a single medium or a plurality of media. The tape-form recording medium 102 may be built into the backup device 100, or may be a type that can be attached to and removed from the backup device 100, or may be a type that is connected to the backup device 100 via any of various kinds of network, etc. The tape-form recording medium 102 is a recording medium which cannot be randomly accessed.

The backup device 100 has a CPU and a storage component. The CPU reads and executes programs stored in the storage component, and thereby operates as a directory structure production component 103, a tape access component 104, a restore directory designation component 106, and a restore data copying component 107. The backup device 100 has a buffer memory 105.

The directory structure production component 103 converts a directory structure D1 of data stored on the recording medium 101 into a multilevel directory structure D2 within the recording medium 101. The specific processing performed by the directory structure production component 103 will be discussed below. The term “directory structure” means a structure that includes a plurality of directories arranged as a tree, and all the data in the highest directory thereof. The expression “data in a directory” means the data stored directly under this directory, and all the data stored directly under all the directories lower than this directory. The expression “directories in a directory” means all the directories lower than the latter directory.

The tape access component 104 reads the multilevel directory structure D2 produced by the directory structure production component 103 from the recording medium 101, and writes to the tape-form recording medium 102.

Next, the method for restoring data backed up on the tape-form recording medium 102 to the recording medium 101 will be described.

The buffer memory 105 is used in restoring the data backed up on the tape-form recording medium 102 to the recording medium 101. More specifically, the buffer memory 105 is a buffer memory for temporarily holding data prior to restoring that data to the recording medium 101 used for restoration. The buffer memory 105 may be of any type, so long as it is a memory that can be randomly accessed, such as an SSD. The buffer memory 105 need not be a recording area on a single drive, and may be a combination of recording areas on a plurality of drives. The buffer memory 105 may be built into the backup device 100, or may be a type that can be attached to and removed from the backup device 100, or may be a type that is connected to the backup device 100 via any of various kinds of network, etc.

The restore directory designation component 106 designates the directory in which the data to be restored is stored, in the restoration of at least some of the data stored in (included in) the multilevel directory structure D2 within the tape-form recording medium 102. The directory designated by the restore directory designation component 106 can be the directory immediately above the data to be restored, and can also be a directory that is higher than the directory immediately above the data to be restored. The specific processing performed by the restore directory designation component 106 will be discussed below.

The tape access component 104 reads all the data in the directory designated by the restore directory designation component 106 from the tape-form recording medium 102, and writes to the buffer memory 105.

The restore data copying component 107 reads from the buffer memory 105 only the data to be restored, out of the data stored in the buffer memory 105, and writes to the recording medium 101 used for restoration. For the sake of simplicity, the same number 101 is assigned to the recording medium 101 in which the data to be backed up was originally stored, but the recording medium 101 in which the data to be restored will be stored may be the same recording medium as the recording medium 101 in which the data to be backed up was originally stored, or may be another recording medium.

Next, the format in which the data is stored on the recording medium 101 will be described.

In general, when video and/or audio data is stored in file format on a recording medium, how these files are stored will vary according to the format of the recorded content or the recording device, the specifications, and so forth. In the recording medium 101, data files for management information (hereinafter referred to as management information files) and main body data (video data and/or audio data) (hereinafter referred to as main body data files) are recorded as separate files.

When a length of time of a single recording operation (corresponds to the segment from the start to the end of recording) is long, the main body data is recorded by being divided up in to a plurality of files along the time axis. For example, if the size of video data recorded in a single recording operation exceeds a specified size, then the video data is recorded as a plurality of files divided along the time axis.

In this embodiment, a unit of data thus divided along the time axis is called a clip (including at least one file), and a group of clips corresponding to a single recording operation is called a shot. A clip includes a management information file and a main body data file.

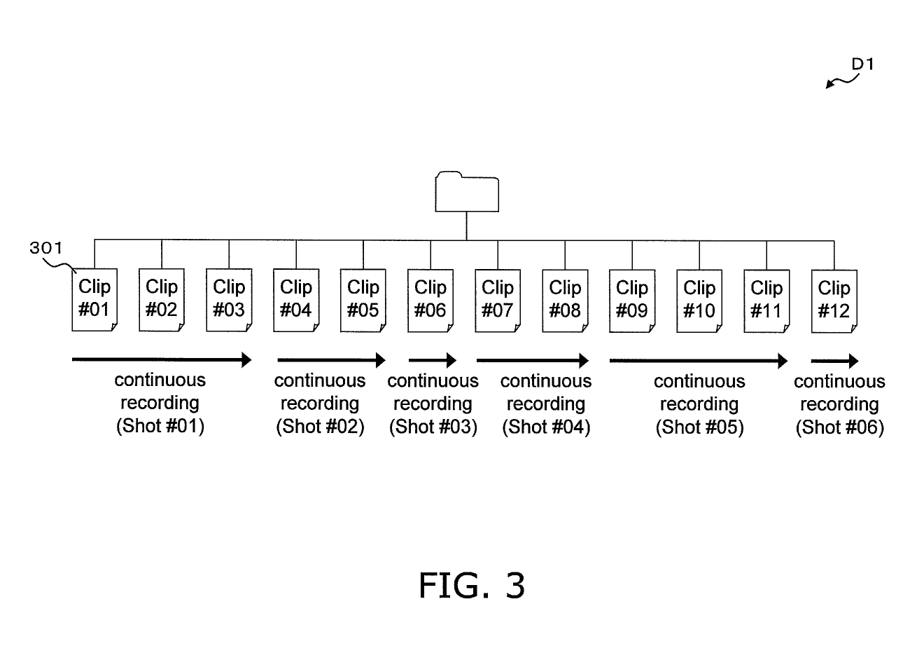

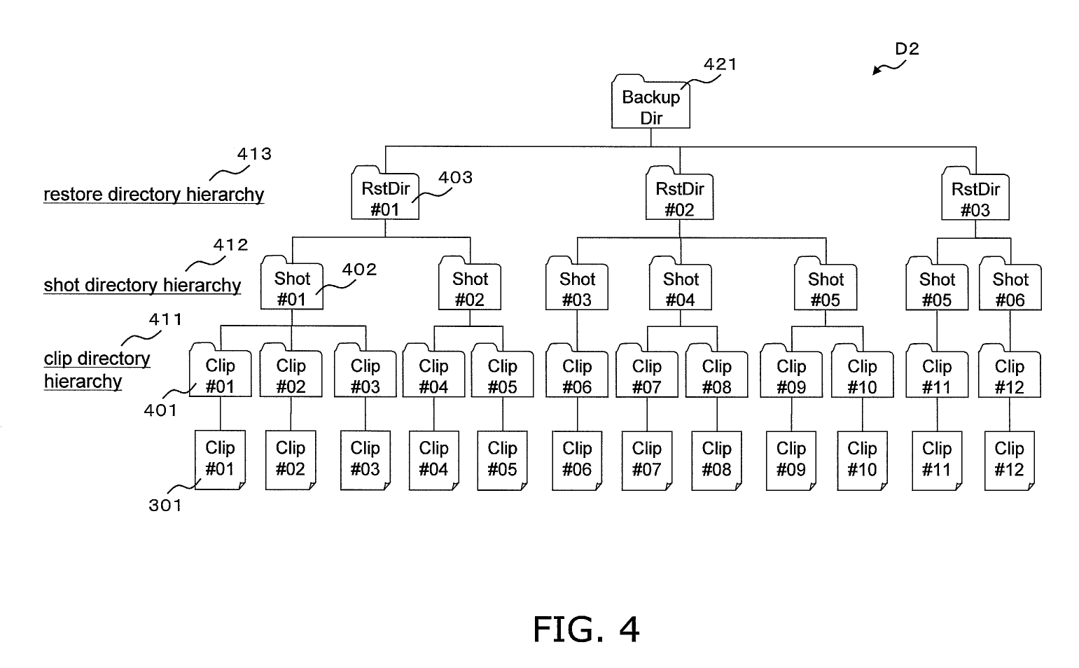

Next, the specific processing performed by the directory structure production component 103 will be described through reference to FIGS. 3 and 4.

FIG. 3 is a diagram of an example of the directory structure D1 of data stored in the recording medium 101.

FIG. 3 is an example of when there are six shots and 12 clips in the recording medium 101. That is, recording operations were performed six times by the user during recording, and the content recorded by these six recording operations were divided up into 12 clips by the recording device (digital video camera or the like) according to the recording times of the six recording operations. The clips 301 are each a group of one or more files that are included in a single clip, and may be made up of a single file or a plurality of files. The clips 301 may also be made up of a plurality of directories. For example, in the case of P2 content (SMPTE RP2002-2006), the clips 301 are each configured as a group of different kinds of files, such as a clip file, a video file, an audio file, and an icon file.

When the directory structure D1 shown in FIG. 3 is backed up to the tape-form recording medium 102, the directory structure production component 103 converts the directory structure D1 into the multilevel directory structure D2 shown in FIG. 4.

First, the directory structure production component 103 produces a backup directory 421 as the top directory (root directory) where the data to be backed up is collected up. In the following description, the size of the data included in all of the clips of clip #1 to clip #12 shall be assumed to be smaller than the recording capacity of the tape-form recording medium 102.

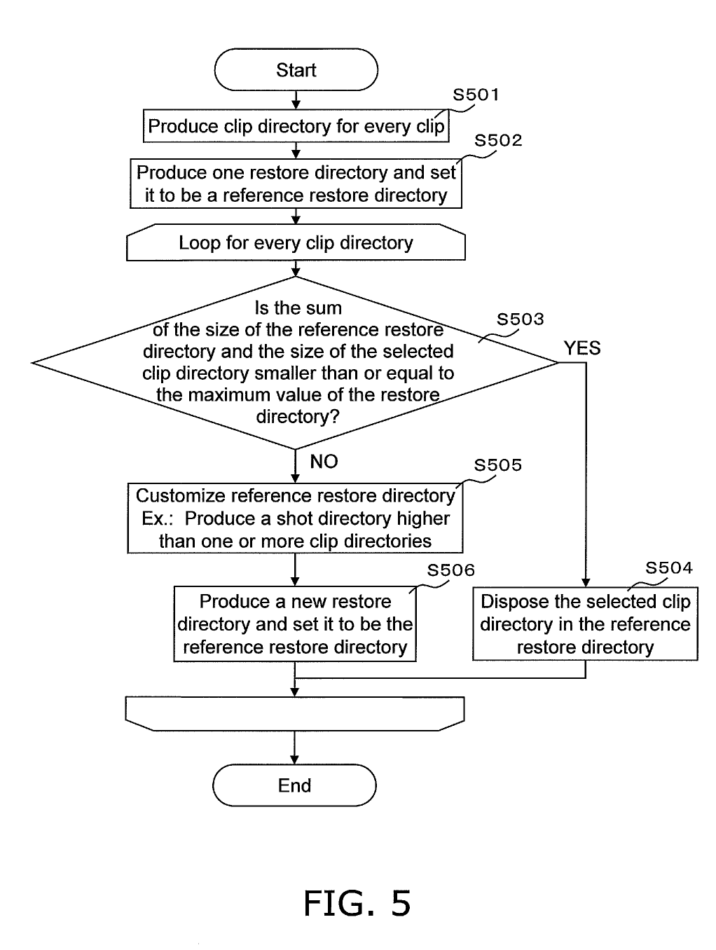

The subsequent flow of the production processing for the multilevel directory structure D2 will be described through reference to the flowchart in FIG. 5.

First, as the processing of S501, the directory structure production component 103 produces one clip directory 401 for each clip 301, and stores each clip 301 directly under the corresponding clip directory 401. In FIG. 4, the 12 directories of clip #1 to clip #12 correspond to the clip directory 401. The directory hierarchy to which the clip directory 401 belongs is called the clip directory hierarchy 411.

Next, as the processing of S502, the directory structure production component 103 produces a single restore directory 403 directly under the backup directory 421, and this restore directory 403 is set to “reference restore directory” in subsequent processing. In the example in FIG. 4, RstDir #01 directory is produced.

The restore directory 403 produced in S502 and S506 described below is a directory that serves as a unit of processing during restoration (restoration unit). In other words, a specific processing is executed for each restoration unit during restoration. The directory structure production component 103 stores one or more clip directories 401 in one restore directory 403. The maximum size for one restore directory 403 is preset. The expression “size of a directory” means the total size of data in that directory. In other words, the “size of a directory” means the total size of the data stored directly under that directory and all the data stored directly under all the directories lower than that directory. The directory structure production component 103 stores one or more clip directories 401 in each restore directory 403 so that the size of each restore directory 403 does not exceed the maximum size (so that it is equal to or smaller than the maximum size). In this embodiment, the maximum size of the restore directory 403 is set to be the same as the recording capacity of the buffer memory 105. In FIG. 4, the three directories RstDir #01 to RstDir #03 correspond to the restore directory 403. The directory hierarchy to which the restore directory 403 belongs is called the restore directory hierarchy 413.

The subsequent processing loop of S503 to S506, which is repeated for every clip directory, causes the directory structure production component 103 to form a directory structure under the restore directory 403.

As the processing of S503, the directory structure production component 103 determines whether or not the selected clip directory 401 can be stored in the reference restore directory 403. The “selected clip directory 401” is the clip directory 401 currently selected to go in a loop. If it is determined that the selected clip directory 401 can be stored, the directory structure production component 103 stores the selected clip directory 401 in the reference restore directory 403 as the processing of S504. In the processing of S503, the determination as to whether or not the selected clip directory 401 can be stored is made based on whether or not the sum of the current size of the reference restore directory 403 and the size of the selected clip directory 401 exceeds the predetermined maximum size of the restore directory 403. If it is determined that the sum exceeds the predetermined maximum size, it is determined that the selected clip directory 401 cannot be stored, but if it is determined that the sum does not exceed the predetermined maximum size, it is determined that the selected clip directory 401 can be stored.

If the determination in the processing of S503 is that the selected clip directory 401 cannot be stored in the reference restore directory 403, the directory structure production component 103 executes the processing of S505. In the processing of S505, the directory structure under the reference restore directory 403 is customized. For example, as the processing of S505, the directory structure production component 103 produces a shot directory 402 that is higher than at least one clip directory 401, as shown in FIG. 4. That is, each clip directory 401 is stored in a specific shot directory 402. At this point, the directory structure production component 103 stores in one shot directory 402 one or more clip directories corresponding to one or more clips belonging to the shot corresponding to that shot directory 402. However, it may be that the clip directories corresponding to the clips belonging to the same shot are stored in a different shot directory 402. The directory hierarchy to which the shot directory 402 belongs is called a shot directory hierarchy 412.

Upon completion of S505, as the processing of S506, the directory structure production component 103 produces one new restore directory 403 directly under the backup directory 421, and sets this restore directory 403 to the new “reference restore directory.” In the example in FIG. 4, the processing of S505 produces the RstDir #02 directory and the RstDir #03 directory. After the processing of S506, the directory structure production component 103 continues the processing loop repeated for every clip directory.

The above processing produces the multilevel directory structure D2 shown in FIG. 4 in which the backup directory 421 is the root directory.

Then, the tape access component 104 reads from the recording medium 101 the multilevel directory structure D2 produced by the directory structure production component 103, and writes to the tape-form recording medium 102. This completes the backup. Upon completion of the backup, the directory structure production component 103 returns the multilevel directory structure D2 in FIG. 4 to the original directory structure D1 in FIG. 3 in the recording medium 101.

In this embodiment, the processing of the flowchart in FIG. 5 was executed as the method for producing the multilevel directory structure D2 shown in FIG. 4, but any method can be used so long as it allows an equivalent multilevel directory structure D2 to be produced.

Also, in this embodiment, the maximum size of the restore directory 403 was set to be the same as the recording capacity of the buffer memory 105, but the maximum size of the restore directory 403 can be set to another value according to the intended use of the backup system and so forth. For example, the maximum size of the restore directory 403 may be a specific size that is no greater than the recording capacity of the buffer memory 105. Alternatively, the maximum size of the restore directory 403 may be the maximum size of data capable of being read out at the same time from the tape-form recording medium 102 to the buffer memory 105 during restoration (the size of the data read unit).

Also, in FIG. 4, the directory names of the clip directories 401 are clip #01 to clip #12, but these directory names can be set as desired.

Also, in FIG. 4, the directory names of the restore directories 403 are RstDir #01 to RstDir #03, but these directory names can be set as desired.

Also, in FIG. 4, the directory names of the shot directories 402 are shot #01 to shot #06, but these directory names can be set as desired.

Also, in FIG. 4, the restore directory hierarchy 413 is the hierarchy directly under the backup directory 421, but may be any hierarchy so long as it is a hierarchy that is lower than the backup directory 421.

Also, in FIG. 4, the shot directory hierarchy 412 is the hierarchy directly under the restore directory hierarchy 413, but may be any hierarchy so long as it is a hierarchy that is lower than the restore directory hierarchy 413. Also, there may be no shot directory 402 belonging to the shot directory hierarchy 412.

Also, in FIG. 4, the clip directory hierarchy 411 is the hierarchy directly under the shot directory hierarchy 412, but may be any hierarchy so long as it is a hierarchy that is lower than the restore directory hierarchy 413.

Also, the restore directories 403 were customized as the processing in S505, but this processing may be omitted.

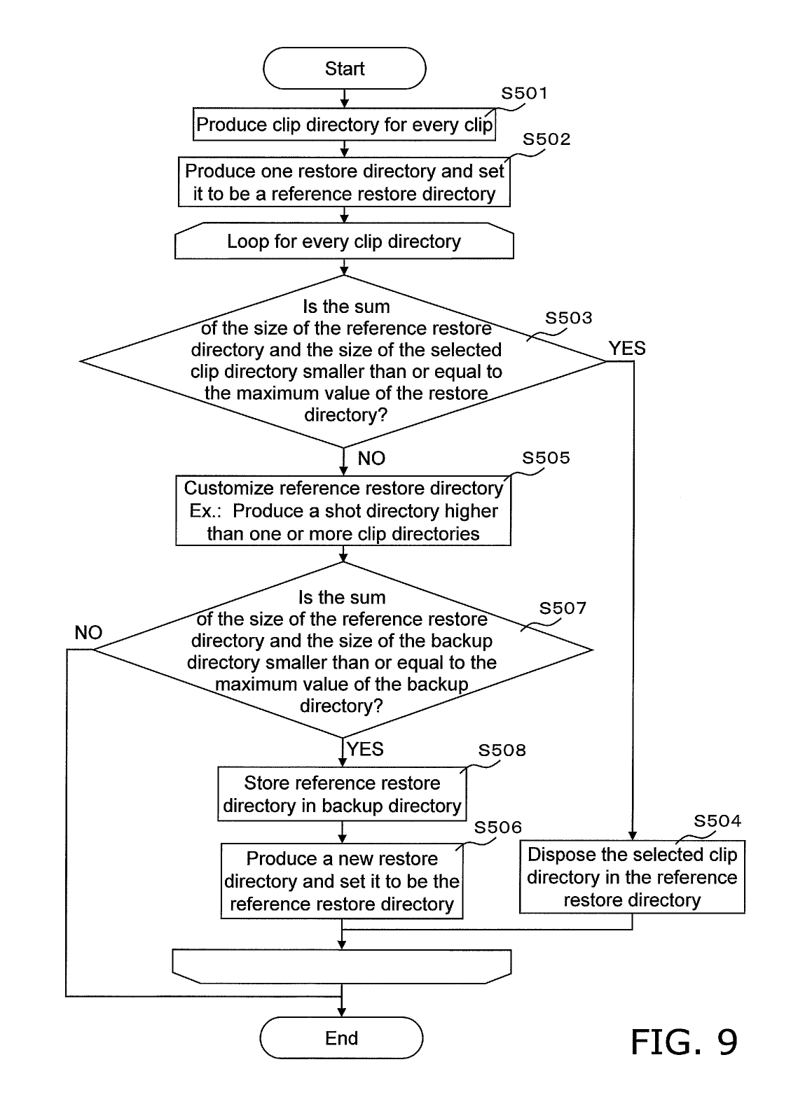

Also, as shown in FIG. 9, the processing of S507 and the processing of S508 may be inserted between the processing of S505 and the processing of S506. As the processing of S507, the directory structure production component 103 determines whether or not the reference restore directory 403 can be stored in the backup directory 421. If it is determined that the reference restore directory 403 can be stored, the directory structure production component 103 stores the reference restore directory 403 in the backup directory 421 as the processing of S508. If it is determined that the reference restore directory 403 cannot be stored, the directory structure production component 103 ends the processing of FIG. 9, and the multilevel directory structure D2 at that point is stored on the tape-form recording medium 102.

In the processing of S507, the determination as to whether or not the reference restore directory 403 can be stored is made on the basis of whether or not the sum of the current size of the backup directory 421 and the size of the reference restore directory 403 exceeds the predetermined maximum size of the backup directory 421. If it is determined that the sum exceeds the predetermined maximum size, it is determined that the reference restore directory 403 cannot be stored and if it is determined that the sum does not exceed the predetermined maximum size, it is determined that the reference restore directory 403 can be stored. In this embodiment, the maximum size of the backup directory 421 is set to be the same as the recording capacity of the tape-form recording medium 102.

In the processing of FIG. 9, the restore directory 403 is added in the backup directory 421 until it is determined that the restore directory 403 can no longer be stored in the backup directory 421. That is, the directory structure production component 103 stores at least one restore directory 403 in the backup directory 421 so that the size of the backup directory 421 does not exceed the maximum size (so that it is equal to or smaller than the maximum size). Viewed from another standpoint, the directory structure production component 103 stores at least one clip 301 in the backup directory 421 so that the size of the backup directory 421 (the same as the size of the multilevel directory structure D2) does not exceed the maximum size (so that it is equal to or smaller than the maximum size).

Next, the method for restoring data backed up on the tape-form recording medium 102 to the recording medium 101 will be described in detail.

During restoration, a method is used in which all of the clips 301 in specific directories (restore target directories) that include the clips 301 to be restored are restored from the tape-form recording medium 102 to the buffer memory 105, instead of a method in which only the clips 301 to be restored are restored. At this point, the restore directory designation component 106 designates at least one restore target directory.

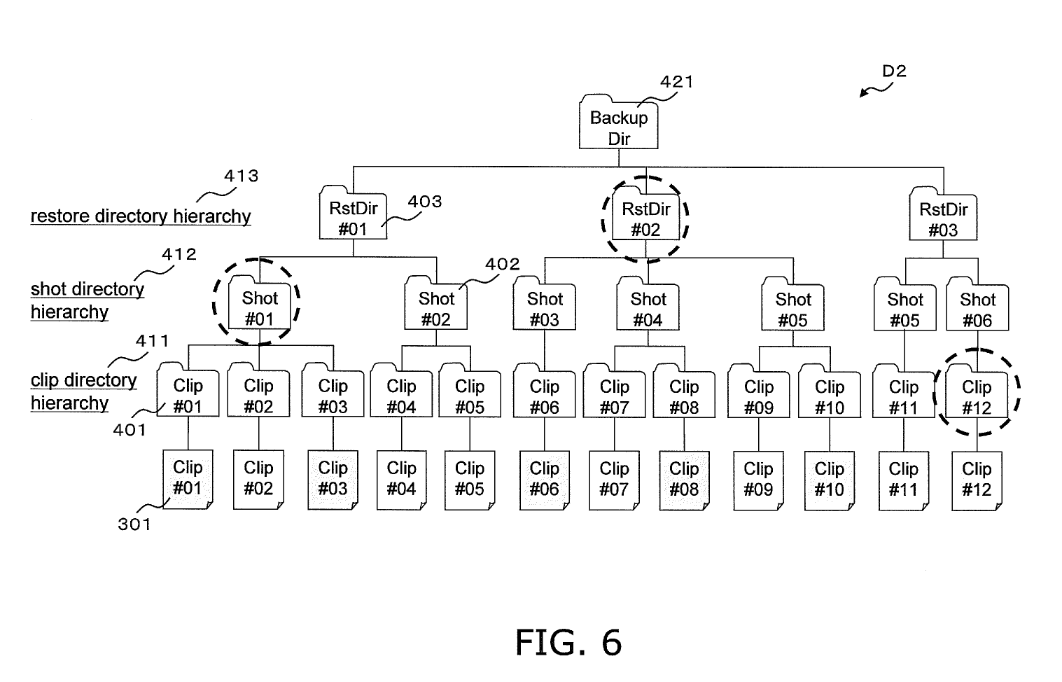

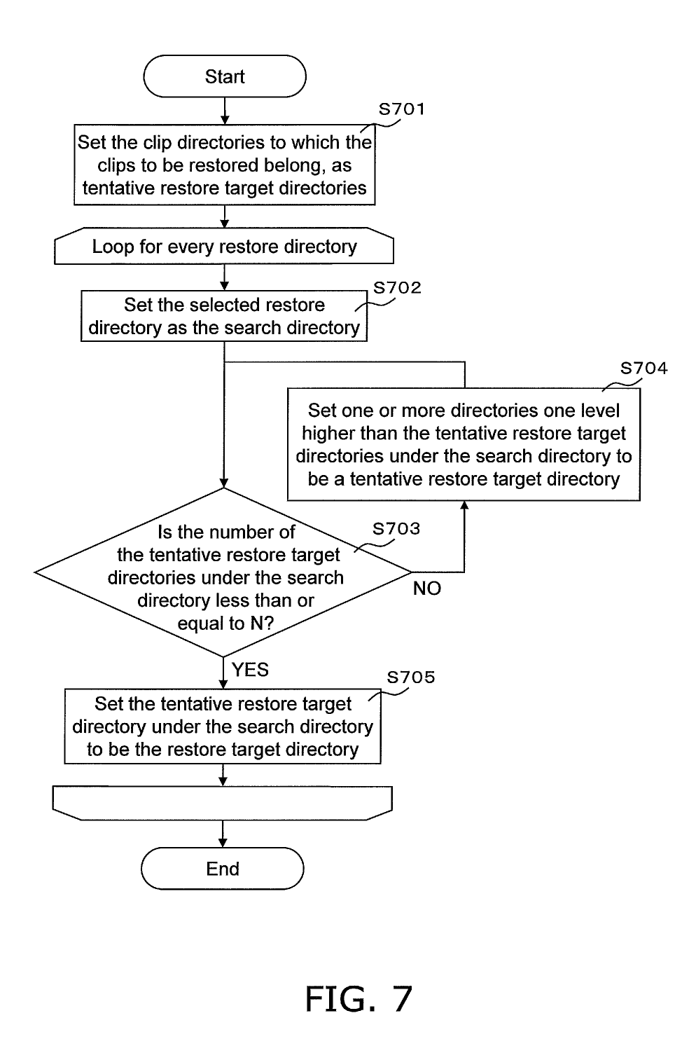

The method by which the restore directory designation component 106 designates the restore target directory will be described through reference to the flowchart in FIGS. 6 and 7.

FIG. 6 shows the multilevel directory structure D2 of the data backed up on the tape-form recording medium 102. Here, the description will be of an example in which the clips 301 to be restored are clip #01, clip #03, clip #06, clip #08, clip #10, and clip #12.

First, as the processing of S701, the restore directory designation component 106 sets as the tentative restore target directories the clip directories 401 in which the clips 301 to be restored are stored. That is, the restore directory designation component 106 sets six clip directories 401, namely, the clip #01 directory, the clip #03 directory, the clip #06 directory, the clip #08 directory, the clip #10 directory, and the clip #12 directory, as the tentative restore target directories.

After the processing of S701, the restore directory designation component 106 executes loop processing in which the processing of S702 to S705 is repeated for every restore directory 403 included in the multilevel directory structure D2.

As the processing of S702, the restore directory designation component 106 sets the selected restore directory 403 as the search directory. The selected restore directory 403 is the restore directory 403 currently selected to go in a loop. That is, in the first processing of S702 after the processing of the loop started, the RstDir #01 directory is the search directory.

Next, as the processing of S703, the restore directory designation component 106 searches one or more tentative restore target directories under the search directory, and determines whether or not the number of the tentative restore target directory or directories under the search directory is less than or equal to N. Here, N is a predetermined value, and is a natural number equal to or greater than 1. The larger is the value of N, the smaller is the amount of data restored in a single restoration operation, but the greater is the number of restoration operations. In this embodiment, the value of N is “1.” In the processing of S703 for the RstDir #01 directory, there are two tentative restore target directories (the clip #01 directory and the clip #03 directory) under the search directory (the RstDir #01 directory), so after the processing of S703, the flow moves on to the processing of S704.

As the processing of S704, the restore directory designation component 106 sets one or more directories one level higher than the tentative restore target directories under the search directory as one or more new tentative restore target directories. More precisely, the tentative restore target directories under the search directory are replaced with one or more directories one level higher than the tentative restore target directories. That is, in the processing of S704 for the RstDir #01 directory, the restore directory designation component 106 specifies the shot #01 directory as the directory one level higher than the clip #01 directory. Similarly, the shot #01 directory is specified as the directory one level higher than the clip #03 directory. Therefore, the result of the processing of S704 for the RstDir #01 directory is that there are five tentative restore target directories: the shot #01 directory, the clip #06 directory, the clip #08 directory, the clip #10 directory, and the clip #12 directory.

In the next processing of S703, the number of one or more tentative restore target directories (the shot #01 directory) under the search directory (the RstDir #01 directory) is less than or equal to N (1), so after the processing of S703, the flow moves to the processing of S705.

As the processing of S705, the restore directory designation component 106 decides one or more tentative restore target directories under the search directory as one or more restore target directories. In the processing of S705 for the RstDir #01 directory, the shot #01 directory is decided as the restore target directory. That is, the restore target directory within the RstDir #01 directory becomes the shot #01 directory.

By the same procedure, the restore target directory within the RstDir #02 directory becomes the RstDir #02 directory, and the restore target directory within the RstDir #03 directory becomes the clip #12 directory.

The restore directory designation component 106 decides one or more restore target directories by the above processing.

After the decision on one or more restore target directories, the tape access component 104 reads all the data under the one or more restore target directories from the tape-form recording medium 102, and writes to the buffer memory 105. After this, the restore data copying component 107 selects only the data to be restored from among all the data under the one or more restore target directories written to the buffer memory 105, and copies it to the recording medium 101 used for restoration.

At this point, the restoration processing by the tape access component 104 of all the data under the one or more restore target directories, and the copy processing by the restore data copying component 107 of the data to be restored are carried out sequentially in units of a restore target directory (on a restore target directory basis).

With the example given above, the restore target directories are the shot #01 directory, the RstDir #02 directory, and the clip #12 directory. Therefore, first the tape access component 104 reads the shot #01 directory (a restore target directory) from the tape-form recording medium 102 and writes to the buffer memory 105. Then the restore data copying component 107 copies clip #01 and clip #03 in the buffer memory 105 to the recording medium 101 used for restoration.

Next, the restore data copying component 107 deletes the shot #01 directory in the buffer memory 105. The tape access component 104 then reads the RstDir #02 directory (a restore target directory) from the tape-form recording medium 102, and writes to the buffer memory 105. The restore data copying component 107 then copies clip #06, clip #08, and clip #10 in the buffer memory 105 to the recording medium 101 used for restoration.

Next, the restore data copying component 107 deletes the RstDir #02 directory in the buffer memory 105. The tape access component 104 then reads the clip #12 directory (a restore target directory) from the tape-form recording medium 102, and writes to the buffer memory 105. The restore data copying component 107 then copies clip #12 in the buffer memory 105 to the recording medium 101 used for restoration.

Restoration processing and copy processing are carried out sequentially as above.

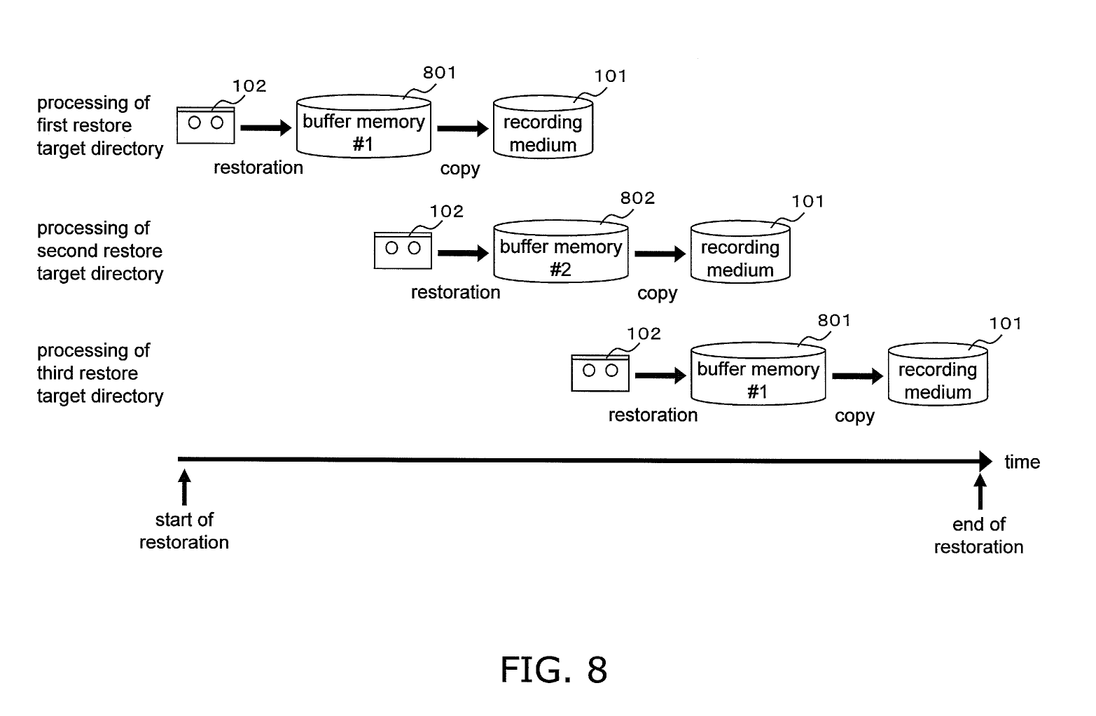

As shown in FIG. 8, two buffer memories 801 and 802 may be in the backup device 100 as a modification example of this embodiment. In this case, the backup device 100 can execute restoration processing from the tape-form recording medium 102 to the buffer memories in parallel with the copy processing from the buffer memories to the recording medium 101 used for restoration. Consequently, the time it takes for total restoration from the tape-form recording medium 102 to the recording medium 101 can be shortened. That is, with the backup device 100, as shown in FIG. 8, a buffer memory #1 is used for the processing of the first restore target directory, a buffer memory #2 is used for the processing of the second restore target directory, and the buffer memory #1 is used again for the processing of the third restore target directory.

Performing pipeline parallel processing as above allows faster restoration from the tape-form recording medium 102 to the recording medium 101.

In this embodiment, the value of N was “1,” but the value of N may be any natural number other than “1,” and a suitable value can be set as dictated by the performance of the system.

Also, the processing of the flowchart in FIG. 7 was executed as the method for deciding one or more restore target directories, but any method may be used, so long as it allows an equivalent one or more restore target directories to be decided.

In this embodiment, the data to be backed up is grouped into a single top directory, so it is possible to back up the data to be backed up on the tape-form recording medium 102 with a single command. Thus, the “seek time” in the tape-form recording medium 102 during backup can be reduced, and the backup can be finished in a shorter time. Furthermore, the directory information can be recorded so that it is grouped together in a single location in the tape-form recording medium 102. Thus, fewer number of the “seek operations” are needed to acquire the directory information in the tape-form recording medium 102, so restoration can be performed more efficiently.

Also, with this embodiment, it is possible to reduce “seek time” in the tape-form recording medium 102 in restoring data that has been divided up into a plurality of segments on the tape-form recording medium 102. Therefore, the total restoration time is reduced. Also, the data to be restored is often selected in unit of a shot (on a shot basis) by a user. Therefore, providing a directory hierarchy such as the shot directory hierarchy 412 makes it possible to minimize the amount of data restored from the tape-form recording medium 102 to the buffer memory 105.

### Embodiment 2

In the capture of 3D video, video data from two systems, namely, the left video data and right video data, is often recorded to separate recording media. In a situation such as this, video data from the same clock time is stored by being divided up into a plurality of recording media.

In this embodiment, we will describe a method for efficiently backing up and restoring data with the same clock time recorded to separate recording media. The data to be backed up and the data to be restored in this embodiment are video data, audio data, or both.

The configuration of the backup device 100 in this embodiment is substantially the same as that in Embodiment 1. In the following, those points that are the same as in Embodiment 1 will not be described again, and the description will focus on the differences from Embodiment 1.

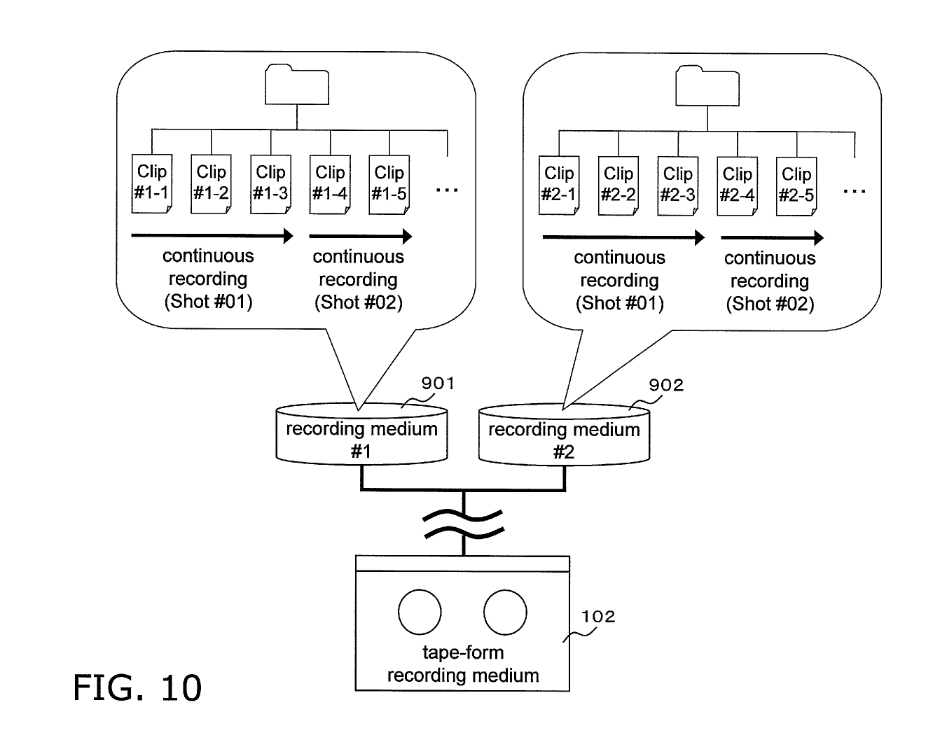

In the example in FIG. 10, clips 301 such as clip #1-1 to clip #1-5 are stored as left video data in a recording medium #1, and clips 301 such as clip #2-1 to clip #2-5 are stored as right video data in a recording medium #2. Clip #1-1 to clip #1-5 are different data with the same clock time as clip #2-1 to clip #2-5, respectively.

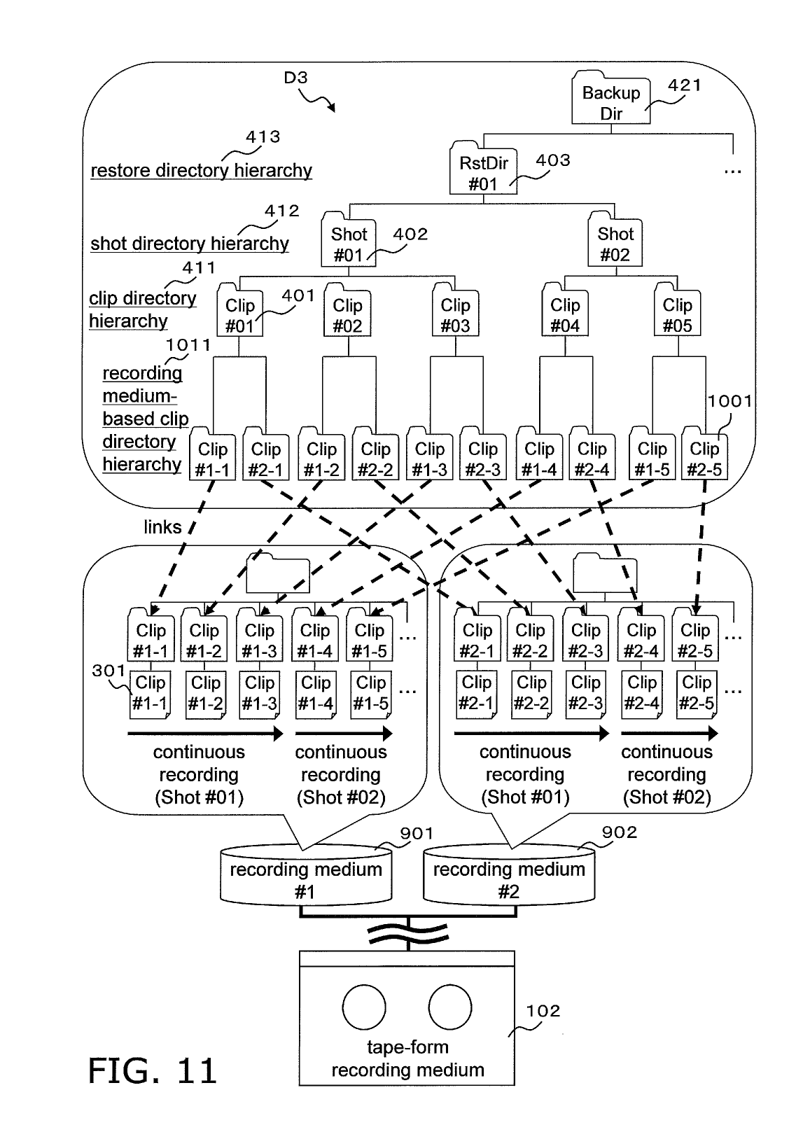

The directory structure production component 103 forms a virtual directory, and creates links from the virtual directory to the recording medium #1 and the recording medium #2, thereby producing the multilevel virtual directory structure D3 shown in FIG. 11. The virtual directory structure D3 may be produced in any storage such as the recording medium #1, the recording medium #2, the buffer memory 105, any drive connected to the backup device 100 (including a drive connected to the backup device 100 via a network), etc.

The processing involved in producing the virtual directory structure D3 will be described through reference to FIG. 11.

The directory structure production component 103 produces a backup directory 421 as the highest directory (root directory) of the virtual directory structure D3, and products a sub-directory structure in the backup directory 421. The sub-directory structure in the backup directory 421 is basically produced according to the flowchart in FIG. 5, as indicated by Embodiment 1. However, the directory structure production component 103 produces two recording medium-based clip directories 1001 for the two different recording media directly under each of the clip directories 401, instead of disposing a main body of the clip 301 directly under each of the clip directories 401. The two clip directories 1001 for separate recording media directly under the same clip directory 401 are directories for storing the clip 301 of the recording medium #1 and the clip 301 of the recording medium #2, respectively. The two clip directories 1001 directly under the same clip directory 401 correspond to the clip #1-1 directory, etc., and to the clip #2-1 directory, etc, respectively. The hierarchy of the directories to which the recording medium-based clip directories 1001 belong is called the recording medium-based clip directory hierarchy 1011.

Next, the directory structure production component 103 produces directories for storing the clips 301, and stores the clips 301 in the corresponding directories. In the example shown in FIG. 11, the directories for storing the clips 301 in the recording medium #1 and the recording medium #2 are clip #1-1 directory to clip #1-5 directory, and clip #2-1 directory to clip #2-5 directory. This processing is unnecessary if each of the clips 301 in the recording medium #1 and the recording medium #2 is already stored in a single directory as shown in FIG. 11.

Next, the directory structure production component 103 forms a link from each of the recording medium-based clip directories 1001 to the directory in which is stored the corresponding clip 301 in the recording medium #1 or #2. As a result, the clips 301 are virtually stored in the recording medium-based clip directories 1001. The links referred to here are symbolic links, for example, buy may be any link so long as it allows data in the directory giving the link to be treated as data in the directory given the link.

As a result of the above processing, the virtual directory structure D3 is produced, in which the data in the plurality of recording media #1 and #2 is collected up. It is preferable that the size of the restore directory 403 does not exceed the predetermined maximum size. In this embodiment, when the size of the restore directory 403 is determined, the size of the data in the directories linked to from the recording medium-based clip directories 1001 is also taken into account. For example, in the case of FIG. 11, the size of the RstDir #01 directory is the combined size of the ten clips of clip #1-1 to clip #2-5. A value that is greater than the combined size of these ten clips is set as the maximum size of the restore directory 403.

Just as in Embodiment 1, the virtual directory structure D3 (including main body data for the clips 301) is backed up by the tape access component 104 to the tape-form recording medium 102.

With this embodiment, the data recorded by being divided up into the plurality of recording media #1 and #2 can be backed up all together in the tape-form recording medium 102.

During restoration, just as in Embodiment 1, the restoration processing is carried out according to the flowchart in FIG. 7.

The method for producing the virtual directory structure D3 need not be the method discussed in this embodiment, and any method may be used so long as it allows an equivalent virtual directory structure D3 to be produced.

Also, in the description of this embodiment, a case in which there were two kinds of data with the same clock time was given as an example, but the backup device 100 in this embodiment can also be applied to a case in which there are three or more kinds of data with the same clock time. In this case, for example, directories may be produced in a number matching the number of kinds of data with the same clock time, in each of the clip directories 401.

Also, in the description of this embodiment, a case in which a plurality of kinds of data with the same clock time were recorded to separate recording media #1 and #2 was given as an example, but a plurality of kinds of data with the same clock time may instead be recorded to the same recording medium.

Also, in the description of this embodiment, left and right video data included in a 3D video image was given as an example of a plurality of kinds of data with the same clock time, but the recording medium 101 in this embodiment can also be applied to other situations, so long as a plurality of kinds of data with the same clock time are recorded. For example, it can be applied to a case in which high-resolution video data is recorded by being divided up into a plurality of low-resolution video data. Also, it can be applied to a case of recording video data in which the subject has been captured from different angles with a plurality of cameras, such as with the broadcast of a sporting event.

With the backup device 100 in this embodiment, a method was employed in which a plurality of kinds of data with the same clock time was backed up by being grouped into the same directory (clip #1 to clip #5 directory). When a plurality of kinds of data with the same clock time are restored at the same time, since the plurality of kinds of data with the same clock time are grouped together in the same directory, restoration can be performed faster than in the past. This is because the plurality of kinds of data with the same clock time can be restored to the buffer memory 105 at once if the restore directory designation component 106 has designated a directory with a higher hierarchy than the clip directory hierarchy 411 as the restore target directory. In actual practice, data with the same clock time backed up in a format such as this is often restored at the same time, which makes the backup device 100 of this embodiment more useful.

### Embodiment 3

In this embodiment, we will describe a method for storing metadata of each clip 301 as a directory name. The clips 301 in this embodiment are video data, audio data, or both.

The configuration of the backup device 100 in this embodiment is substantially the same as that in Embodiment 1. Those points that are the same as in Embodiment 1 will not be described again, and the description will focus on the differences from Embodiment 1.

Metadata is additional information about the clips 301. For example, metadata for video data can be time code information, duration (the length of the video data), or other such information. Usually, metadata is embedded in a main body data file, or listed in a management information file. Therefore, to acquire metadata, it is usually necessary to read the information inside a data file included in a clip 301. That is, when the metadata for data backed up to the tape-form recording medium 102 is read, it is necessary to restore the backed up main body data file or management information file.

In view of this, in this embodiment, the directory structure production component 103 produces directories for metadata at the point of backup, and sets the contents of the metadata as the directory names for these directories.

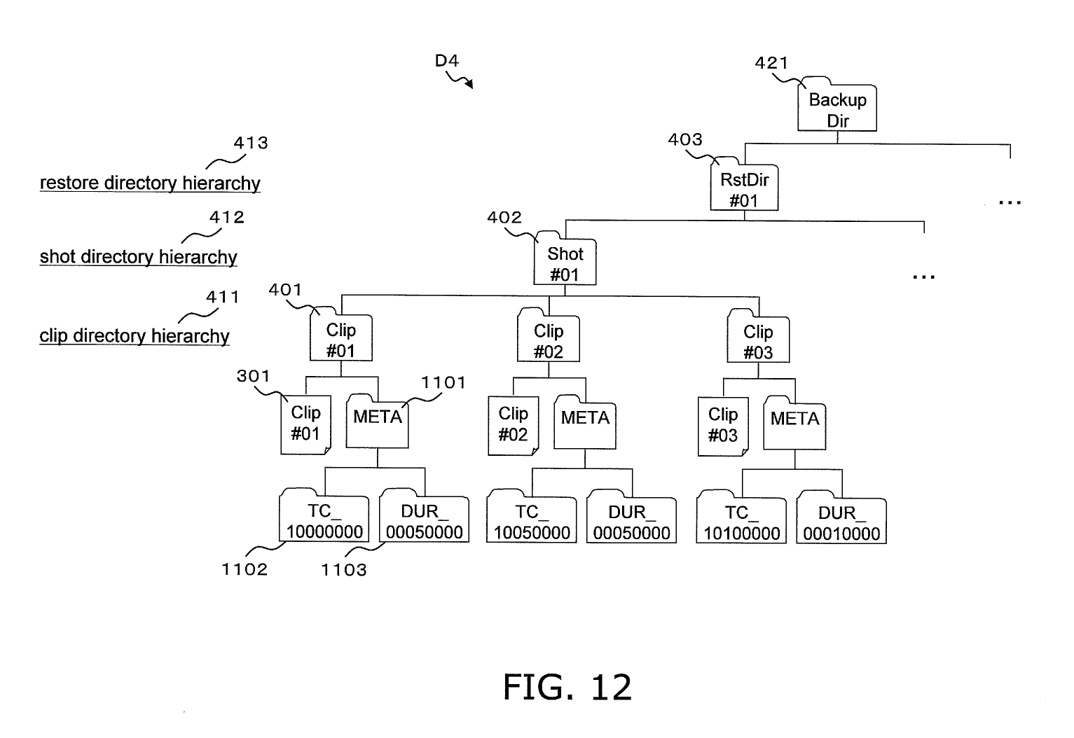

FIG. 12 shows an example of a multilevel directory hierarchy D4 pertaining to this embodiment.

The directory structure production component 103 produces one meta directory 1101 directly under each clip directory 401 in the multilevel directory structure D2 produced in Embodiment 1, and produces two directories with directory names indicating the contents of the metadata directly under each meta directory 1101. In the example in FIG. 12, the directory structure production component 103 produces a TC directory 1102 having a directory name indicating time code information, and produces a DUR directory 1103 having a directory name indicating duration information. In FIG. 12, the time code of clip #01 is “10:00:00:00,” and the duration of clip #01 is “00:05:00:00.”

The backup device 100 backs up the directory structure D4 thus produced to the tape-form recording medium 102 by the same method as in Embodiment 1.

The directory structure D4 and the directory names shown in FIG. 12 are just examples, and any kinds of metadata may be defined along the same lines. The number of directories for metadata is not limited to two, and may be one, or may be three or more.

Also, in FIG. 12, the directory structure production component 103 produced the meta directory 1101 for storing directories for various metadata. However, the meta directory 1101 may be omitted, and a directory for various metadata disposed directly under the clip directory 401. The directory for various metadata can be disposed in a directory belonging to any hierarchy, so long as it is a hierarchy that is lower than the clip directory hierarchy 411.

As discussed above, by setting metadata as a directory name, it becomes possible to determine what data is stored in the directory structure D4 merely by referring to the directory information, without restoring the data files within the tape-form recording medium 102. Directory information is stored separately from the directory structure D4 in the tape-form recording medium 102. Also, when the user wishes to restore only a specific clip 301 referred to with editing information (play list, EDL, etc.), for example, it is possible to identify the clip 301 to be restored on the basis of time code information listed in the editing information, and information about the directory names of directories such as the TC directory 1102 and/or the DUR directory 1103.

One novel effect of the data structure production method disclosed herein is that the seek time can be reduced when data is backed up to a recording medium; and then, just part of the data is restored from the recording medium. As a result, the time for restoration of data will be reduced.

### INDUSTRIAL APPLICABILITY

The data structure production method pertaining to the present invention is used, for example, in systems that back up video data and/or audio data to a recording medium (particularly a recording medium which cannot be randomly accessed, such as a tape-form recording medium).

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms “including,” “having,” and their derivatives. Also, the terms “part,” “section,” “portion,” “member,” or “element” when used in the singular can have the dual meaning of a single part or a plurality of parts. Accordingly, these terms, as utilized to describe the above embodiments, should be interpreted relative to a data structure production method used during the backup of video data and/or audio data and to a backup device that makes use of this method.

Additionally as used herein, the term “configured” as used herein to describe a component, section, or part of a device includes hardware and/or software that is constructed and/or programmed to carry out the desired function.

Moreover, the term “and/or” when used in a list of two or more items, means that any one of the listed items can be employed by itself, or any combination of two or more of the listed items can be employed. For example, if a system is described as backing up A and/or B to a recording medium, the system can backup A alone, B alone, or A and B together.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. A data structure production method for producing a multilevel directory structure in a backup device, the multilevel directory structure includes target data having at least one of video data and audio data, the method comprising:
producing a first directory that establish a first directory hierarchy;
producing at least one second directory that establish a second directory hierarchy lower than the first directory hierarchy, the target data being stored in the at least one second directory; and
storing the at least one second directory in the first directory provided the first directory is less than or equal to a predetermined size.

2. The data structure production method according to claim 1, further comprising
backing up the multilevel directory structure to a first recording medium coupled to the backup device, the first recording medium being non-randomly accessible.

3. The data structure production method according to claim 2, wherein
the predetermined size is less than or equal to the size of a buffer memory which is used to retrieve at least part of the target data to be restored from the first recording medium.

4. The data structure production method according to claim 2, wherein
the predetermined size is the maximum size of target data read out at once from the first recording medium when restoring at least part of the target data.

5. The data structure production method according to claim 2, wherein
the producing of the first directory includes producing at least one first directory.

6. The data structure production method according to claim 5, further comprising
producing a third directory that establish a third directory hierarchy higher than the first directory hierarchy; and
storing the at least one first directory in the third directory provided the third directory is less than or equal to the size of the first recording medium.

7. The data structure production method according to claim 1, further comprising
producing a plurality of fourth directories that establishes a fourth directory hierarchy lower than the second directory hierarchy, each of the at least one second directory being associated with the plurality of fourth directories; and
storing different target data recorded at the same time in the plurality of fourth directories to correspond to the associated at least one second directory

8. The data structure production method according to claim 1, further comprising
producing a fifth directory that establishes a fifth directory hierarchy lower than the second directory hierarchy, the fifth directory being provided for each of the at least one second directory; and
naming the fifth directory to correspond to metadata of the target data stored in the corresponding at least one second directory.

9. A backup device configured to back up a multilevel directory structure to a first recording medium coupled to the backup device, the backup device comprising:
a directory structure production component configured to use the data structure production method according to claim 1 to produce the multilevel directory structure; and
a recording medium access component configured to back up the multilevel directory structure produced by the directory structure production component to the first recording medium.

10. The backup device according to claim 9, further comprising
a restore directory designation component configured to designate at least one restore target directory as the directory that stores the target data which is to be restored to a second recording medium coupled to the backup device, each of the at least one restore target directory being comparable to the first directory or each of the at least one restore target directory being tiered under the first directory provided the number of restore target directories corresponding to each of the at least one first directory is less than or equal to a predetermined number;
a buffer memory configured to temporarily store all of the target data in the at least one restore target directory designated by the restore directory designation component; and
a restore data copying component configured to select the target data to be restored from among all of the target data stored in the buffer memory and copy the selected target data to a second recording medium coupled to the backup device.
